(19) United States
(12) Patent Application Publication
(10) Pub. No.: US 2012/0027653 A1
(43) Pub. Date: Feb. 2, 2012

(54) CATALYTIC COMPOSITION FOR TREATING COAL COMBUSTION GASES, METHOD FOR PREPARING SAME, CATALYTIC SYSTEM INCLUDING SAME, AND USE THEREOF

(76) Inventors: Patrick Da Costa, Pantin (FR); Malgorzata Adamowska, Gliwice (PL); Andrzej Krzton, Gliwice (PL); Gerald Djega-Mariadassou, Igny (FR)

(21) Appl. No.: 13/062,554

(22) PCT Filed: Sep. 23, 2009
(86) PCT No.: PCT/FR09/51800

§ 371 Date: Oct. 19, 2011

(30) Foreign Application Priority Data
Sep. 24, 2008 (FR) 0805250

(51) Int. Cl. B01D 53/86; B01J 21/06

(52) U.S. Cl. 423/210; 502/304

(57) ABSTRACT

The invention relates to a catalytic composition for treating coal combustion gases, to a method for preparing said composition, to a catalytic system having such a composition, and to the use of the catalytic composition for treating coal combustion gases. The catalytic composition is made of particles of a solid composition cCeO₂zZrO₂ containing rhodium in the form of Rh₂O₃ and rhodium in the form of Rh⁴⁺.

### BACKGROUND OF THE INVENTION

The present invention relates to a process for treating gases resulting from the combustion of coal.

### DESCRIPTION OF THE PRIOR ART

The gases resulting from the combustion of coal contain various constituents some of which are toxic and/or polluting. These are especially NO, CO, CO₂, volatile hydrocarbons such as benzene, toluene or propane, and solid particles, the composition of which depends on the quality of the coal.

The emission of nitrogen oxides originating from fixed sources is controlled by primary methods (action on the fuel, action on the combustion: optimization of the combustion parameters, modification of the construction of the boilers) and by secondary methods (action on the gaseous effluent). The primary methods make it possible to reduce the emissions of nitrogen oxides by at most 50%, since it is not possible to date to modify the processes in order to achieve 100%.

Among the secondary methods, selective catalytic reduction by ammonia (SCR—NH₃) is the only catalytic technology used for reducing the emission of nitrogen oxides into the atmosphere. This technology is only used for high-power boilers. However, the reduction with ammonia generates significant costs for the installation, it requires the storage of NH₃, and it has a high risk of environmental contamination, which makes it unsuitable for use in an urban environment, for high-power boilers.

### SUMMARY OF THE INVENTION

The objective of the present invention is to provide a catalyst which makes it possible to substantially reduce the nitrogen oxide content of gases resulting from the combustion of coal.

A subject of the present invention is a catalytic composition for the treatment of coal combustion gases, a process for preparing said composition, a catalytic system bearing said composition, and the use of the catalytic composition for the treatment of coal combustion gases.

The catalytic composition of the present invention is composed of particles of a cCeO₂,zZrO₂ solid solution bearing rhodium in the form of Rh₂O₃ and rhodium in the form of cationic rhodium Rh⁴⁺.

The catalytic composition is prepared by a process that consists in bringing a cCeO₂,zZrO₂ mixed oxide powder into contact with an aqueous solution of Rh(NO₃)₃, then in subjecting the powder impregnated by the solution to a heat treatment.

The catalytic system according to the invention comprises a porous ceramic structure in which the surface of the pores is covered by the catalytic composition.

The process for treating the coal combustion gases consists in passing the gases to be treated over the catalytic composition, in particular through a powder of the catalytic composition or through a catalytic system bearing the catalytic composition.

The catalytic composition of the present invention is composed of particles of a solid solution of cerium zirconium oxide cCeO₂,zZrO₂ in which 0.08≦c/z≦4.1, said particles bearing rhodium, wherein:
the total amount of rhodium is less than 1.3% by weight relative to the total weight of the catalytic composition;
at least 50% by weight of the total amount of rhodium is in the form of Rh₂O₃, said amount being determined by X-ray photoelectron spectrometry; and
the additional amount of rhodium is composed of rhodium in the form of cationic rhodium, that is to say in the form of Rh⁴⁺.

### DETAILED DESCRIPTION OF THE PREFERRED EMBODIMENTS

In one particular embodiment, the c/z ratio of the solid solution of cerium zirconium oxide is 1.63, which corresponds to the atomic composition Ce_{0.62}Zr_{0.38}O₂.

It is preferable that the catalytic composition contains from 0.65% to 1.25% by weight of Rh₂O₃ and from 0.05 to 0.65% by weight of rhodium in Rh⁴⁺ form.

The catalytic composition is prepared by a process consisting in bringing a powder of cerium zirconium oxide cCeO₂,zZrO₂ in which 0.08≦c/z≦4.1 into contact with an aqueous solution of rhodium precursor, then in subjecting the powder impregnated by the solution to a heat treatment. In said process the rhodium precursor is rhodium nitrate, and the heat treatment comprises, in this order, at least:
a step of removing water, during which the nitrate is converted to Rh₂O₃;
a step of reducing to a temperature of less than 350° C., said step aiming to stabilize the rhodium at the surface of the cerium zirconium oxide; then
a calcination step, which aims to oxidize the active phase.

According to this process, the reduction step is necessarily carried out before the calcination step and makes it possible to obtain the mixture of Rh₂O₃ and of Rh⁴⁺. In Rh₂O₃, the rhodium is in the form of Rh³⁺. Inversion of the reduction and calcination steps is not possible. Indeed, if the calcination step was carried out before the reduction step, the final rhodium then obtained would be composed of a mixture of Rh₂O₃ and of rhodium Rh⁰ and not a mixture of Rh₂O₃ and of Rh⁴⁺.

The cerium zirconium oxide (mixed oxide) cCeO₂,zZrO₂ used for the preparation of the catalytic composition is a solid solution of ceria and of zirconia (powder), which may be prepared by the conventional processes well known to a person skilled in the art, for example, by coprecipitation, by the sol-gel method, by a hydrothermal route or in microemulsion.

Use may, in, particular, be made of a powder of cerium zirconium oxide cCeO₂,zZrO₂ which has the composition Ce_{0.62}Zr_{0.38}O₂ and which may be prepared, for example, by the sol-gel method or by a hydrothermal route.

It is preferable for the volume of aqueous solution to be at least equivalent to the volume needed to fill the pores of the mixed oxide with the solution of Rh(NO₃)₃, so as to ensure a homogeneous distribution of the rhodium in the pores of the mixed oxide. The process may be carried out by putting the mixed oxide powder into suspension in the solution of rhodium nitrate. It is however preferable to use small volumes of nitrate solution, in order to limit the energy needed to remove the water.

Since the excess water is removed by evaporation, the total amount of rhodium present in the rhodium nitrate solution attaches to the mixed oxide. Thus, it is easy to determine the concentration of the rhodium nitrate solution as a function of the volume needed for the impregnation of the mixed oxide powder and of the desired rhodium concentration in the catalytic composition, or to determine the volume of solution needed as a function of its rhodium nitrate concentration and of the desired rhodium concentration in the catalytic composition.

In one preferred embodiment, the heat treatment carried out on the Ce₀₆₂Zr_{0.38}O₂ powder impregnated by the solution of rhodium nitrate comprises, in this order, the following steps:
a) maturation by holding the impregnated powder at ambient temperature for at least 3 hours;
b) drying by holding at a temperature of 90° C. to 110° C., preferably above 105° C.;
c) reduction of Rh₂O₃ formed at the end of step b) to Rh⁰, and reduction of the Ce_{0.62}Zr_{0.38}O₂ support by holding under a stream of hydrogen at a temperature of 250° C. to 320° C.; then
d) calcination at a temperature of 420° C. to 520° C. for at least 2 hours, in order to reoxidize the rhodium Rh⁰ to Rh₂O₃ and Rh⁴⁺.

During the calcination, it is possible to observe, in general, the crystallization of the amorphous phases, the sintering of the active phase, the interaction between the active phase and the support, and a surface segregation.

In one particular embodiment, a sub-step of holding at a temperature of 70° C. to 90° C. is carried out between step a) and step b) in order to avoid a thermal shock in the material which would cause too rapid a decomposition of the rhodium nitrate.

During step c), the material resulting from step b) is heated, preferably with a rate of less than 10° C. per minute. A low rate makes it possible to better control the reduction reaction of the cCeO₂,zZrO₂ support and of Rh₂O₃. If step c) is carried out at a temperature above 350° C., the material tends to sinter. This is why, as a precautionary measure, the reduction temperature preferably used during step c) is 250° C. to 320° C. in order to remove any risk of the material sintering. The reduction which takes place during step c) makes it possible to stabilize the rhodium in the Rh⁰ form at the surface of the mixed oxide.

The material resulting from step c) is brought to the temperature of step d) preferably at a heating rate of 1 to 5° C. per minute.

The process for treating the coal combustion gases consists in passing said gases over a catalytic composition according to the invention, preferably at a temperature that varies from 277° C. to 473° C., and more preferably still at 357° C. In this temperature interval, the removal rate of nitrogen oxide changes from 20% (at 277° C.) to 50% (at 357° C.) then to 30% (at 473° C.).

It is preferable to submit the catalytic composition obtained at the end of step d) to an in situ pretreatment by a mixture of oxygen at 20% by volume in argon (20% O₂ in Ar) before its use for the treatment of the combustion gases, in order to purge the surface of the catalyst of adsorbed molecules such as for example CO₂ and H₂O which may modify the profile, and in order to ensure the final oxidized surface finish. The pretreatment consists of a heat treatment comprising a step of slow heating (from 1 to 3° C./min) up to a temperature of 450 to 550° C., a step of holding at this temperature, and a step of cooling to ambient temperature.

In a first embodiment, the gases to be treated are brought into contact with a layer of catalytic composition in powder form, with a sufficient flow rate in order to agitate the powder so as to ensure a good contact between the catalytic composition and the gas. In this embodiment, it is possible to use a reactor which contains the catalytic composition in powder form placed as a thin layer on quartz wool, and the gaseous mixture to be treated is passed over the powder with a sufficiently high gas flow rate to agitate the powder.

In a second embodiment, use is made of a catalytic structure composed of a porous ceramic monolith, the pores of which are covered with the catalytic composition.

The present invention is illustrated by the following exemplary embodiments, to which it is not however limited.

### Example 1

### Preparation of a Catalytic Composition

A catalytic composition was prepared by using rhodium nitrate Rh(NO₃)₃.2H₂O (Alfa Aesar−purity>99.9%) and a solid solution of ceria-zirconia-mixed oxide Ce_{0.62}Zr_{0.38}O₂ prepared via a hydrothermal route.

A solution of rhodium nitrate was prepared by dissolving the rhodium nitrate Rh(NO₃)₃.2H₂O in distilled water at ambient temperature, in order to obtain a solution, the nitrate concentration C[nitrate] of which, expressed as % by weight, is given in table 1 below. Next, 2.5 ml of this solution were added dropwise to 5 g of Ce_{0.62}Zr_{0.38}O₂ powder while stirring vigorously, so as to carry out an incipient wetness impregnation of the mixed oxide by the rhodium nitrate.

The suspension obtained was subjected to a heat treatment comprising the following successive steps:
drying at ambient temperature for 12 hours;
drying in an oven at 80° C. for 3 hours in order to evaporate the water;
heating up to 110° C. and holding at this temperature for 24 hours;
reduction: under a hydrogen atmosphere, heating up to 300° C. with a temperature ramp of 10° C./min and holding at this temperature for 1 hour;
calcination according to the following temperature profile: heating up to 500° C. at a rate of 3° C./min, holding for 2 hours at 500° C., then cooling to 30° C.

Several samples were prepared according to the procedure above, by modifying the concentration C[nitrate] of the nitrate solution (% by weight), in order to obtain samples having various total rhodium contents [Rh] (% by weight), including the Rh⁴⁺ content and the Rh₂O₃ content. The nitrate concentration of the nitrate solution, and also the total rhodium content of the catalytic composition [Rh] and its specific surface area S (in m²/g), are listed in table 1 below.

### Characterization of the Catalytic Composition

### Elemental Analysis

The chemical constituents of the samples were determined by inductively coupled plasma atomic emission spectroscopy (ICP-AES). The rhodium content of each sample is indicated in table 1.

### Specific Surface Area

The total surface area of a sample was studied on the basis of the nitrogen adsorption/desorption isotherms at −203° C. using a MICROMETRICS® ASAP 2010 machine. Before adsorption, the samples were degassed under vacuum “in situ” at 250° C. for 12 h and then at 350° C. for 2 hours. The specific surface area is indicated in table 1.

TABLE 1

| | C [nitrate] | | |
|---|---|---|---|
| Sample | (%) | [Rh] | S (m²/g) |
| 1c | 0 | 0 | 131 |
| 1 | 0.0095 | 0.15 | 115 |
| 2 | 0.0216 | 0.35 | 109 |
| 3 | 0.0234 | 0.38 | 104 |
| 4 | 0.0318 | 0.52 | 105 |

### X-Ray Diffraction

The powder diffraction pattern of a sample was recorded on a SIEMENS® D500 diffractometer that is automated and equipped with a copper anticathode CuKα (λ=1.5418 Å, acceleration voltage 30 kV). The crystalline structure of the samples and the Miller indices (hkl) of the diffraction lines were determined by comparison of the diffraction patterns recorded with the JCPDS files published by the “Joint Committee on Powder Diffraction Standards”.

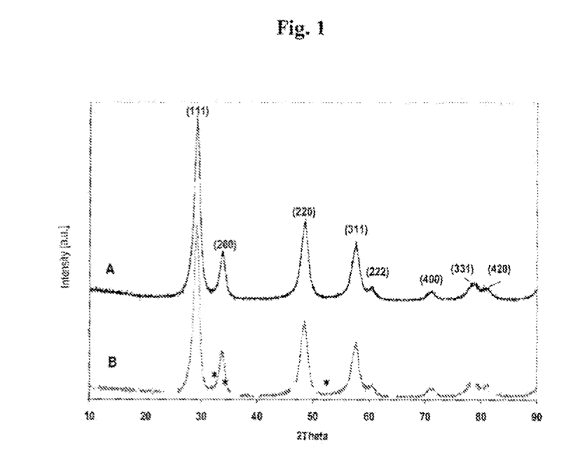

In FIG. 1, curve A represents the diffraction pattern recorded for sample 1c (Ce_{0.62}Zr_{0.38}O₂ support alone) and curve B represents the diffraction pattern recorded for sample 4 of the Rh(N)/Ce_{0.62}Zr_{0.38}O₂ catalytic composition. The support and the catalyst were precalcined at 500° C. (773 K) before the XRD analysis in air for 2 h.

It appears that the diffraction pattern B of the sample according to the invention is identical to the diffraction pattern A of the mixed oxide without rhodium. On the diffraction pattern B, the nominal position of three most intense lines of the rhodium oxide Rh₂O₃ is indicated by the symbol *. It thus appears that X-ray diffraction does not make it possible to identify the presence of Rh₂O₃, at the very low concentrations necessary for the catalysis. The diffraction peaks of the CeO₂—ZrO₂ mixed oxide mask the diffraction peaks of the rhodium oxide.

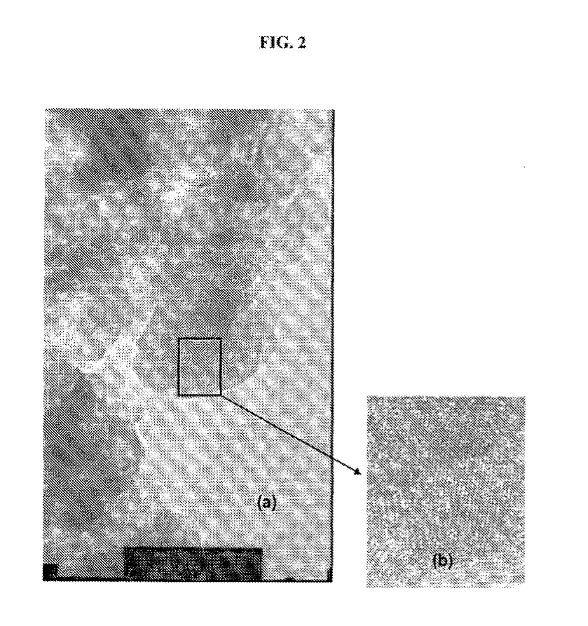

However, the X-ray diffraction pattern of orthorhombic Rh₂O₃ and that of rhombonedral Rh₂O₃ show a line at 1.71 Å characteristic of the rhombohedral Rh₂O₃ which cannot be confused with the lines of the CeO₂—ZrO₂ mixed oxide. This line corresponds to an inter-reticular distance of 1.71 Å that can be attributed to the planes (116), and it is of high intensity (50%). The presence of rhodium was consequently detected by the measurement, on the high-resolution transmission electron microscopy (HRTEM) images, of the fringe spacings of Rh₂O₃. This measurement was carried out in two stages:
scanning by electron diffraction (EDS) of the fields of the microscope. The EDS spectrum (not represented) shows the presence of a small peak of Rh in the field observed.
taking a high-resolution (600 k) image of the marked peak. The high-resolution image is represented in FIG. 2a;
digitization of the high-resolution image, and measurement of the network fringes either directly on the enlarged image represented in FIG. 2b or by Fourier transform: d1=1.75 Å; Rh₂O₃ Rhomb 1.71 Å (116). The zone of the fringes of the rhombohedral Rh₂O₃ is inscribed within an area of irregular shape of 10×5 nm, which shows that the particle of Rh₂O₃ has a small thickness (2 to 3 layers of atoms approximately).

It should be noted that one of the lattice parameters of rhombohedral Rh₂O₃ (5.12 Å) is close to the lattice parameter of CeO₂—ZrO₂ (5.24 Å), which favors the crystallization of Rh₂O₃.

### Characterization by X-Ray Photoelectron Spectrometry (XPS)

The XPS spectrum of the various samples was obtained using a Vacuum Science Workshop ESCA 150 spectrometer equipped with a hemispherical analyzer (diameter of the order of 300 mm). The powders were attached to a double-sided adhesive tape. The X-ray irradiation of the sample was carried out under ultravacuum conditions (3.10⁻⁹ kPa) with a source of Mg Kα type (hν=1253.6 eV). The XPS spectra take into account the oxidation state of an element. Each oxide state has a well-defined bond energy (eV).

The amounts of particular species with Ce, Zr and Rh present in the samples were calculated using the normalized intensity of the 3d peaks (by deconvolution of the 3d_{3/2} and 3d_{5/2} bands) and are presented in table 2 below:

TABLE 2

| E | Ce³⁺3d | Ce⁴⁺3d | Zr⁰3d | Zr³⁺3d | Zr⁴⁺3d | Rh⁰3d | Rh³⁺3d | Rh⁴⁺3d |
|---|---|---|---|---|---|---|---|---|
| I | 8361 | 17044 | 312 | 987 | 2425 | 0 | 272 | 42 |
| EL[eV] | | | 178.8 | 180.6 | 182.0 | 307.0 | 308.5 | 310.5 |
| % T | 32.9 | 67.1 | 8.4 | 26.5 | 65.1 | 0 | 86.6 | 13.4 |
| ASF | 10 | | 2.1 | | | 4.1 | | |
| I/ASF | 836.1 | 1704.4 | 148.6 | 470 | 1154.8 | 0 | 66.3 | 10.2 |

| | | | |
|---|---|---|---|
| □I/ASF | 2540.5 | 1773.3 | 76.6 |
| at % Me | 57.9 | 40.4 | 1.7 |

In this table, the abbreviations used have the following meaning:
E: particular species Ce, Zr, Rh
I: intensity of the 3d peaks of the particular species
EL: bond energy of 3d_{5/2} electrons of the particular species
% T: percentage content of the particular species
ASF: atomic sensitivity factor of the elements
I/ASF: normalized intensity of the peaks of the particular species
□I/ASF: sum of the normalized intensities of the Ce, Zr and Rh peaks
at % Me: percentage content of the particular elements in the surface nanolayers.

These XPS results confirm that, in the samples of catalytic composition according to the invention, the majority of the total rhodium exists in the +3 degree of oxidation corresponding to rhodium in the Rh₂O₃ form (86.6% by weight) and only 13.4% by weight of the total rhodium is present in cationic form in the +4 degree of oxidation.

### TPR Profile

The reducibility of the ceria-zirconia mixed oxide, with and without rhodium, was studied quantitatively by a temperature-programmed reduction (TPR). The samples were heated under a mixture of 5% by volume of hydrogen in argon (Ar/5% H₂) up to 950° C., then cooled to ambient temperature under the flow of the Ar/5% H₂ reaction mixture. The reactor was then purged with argon before being opened and brought into contact with the air. The total flow rate of the reaction mixture was set at 0.025 l/min and the temperature ramp at 7.5° C./min.

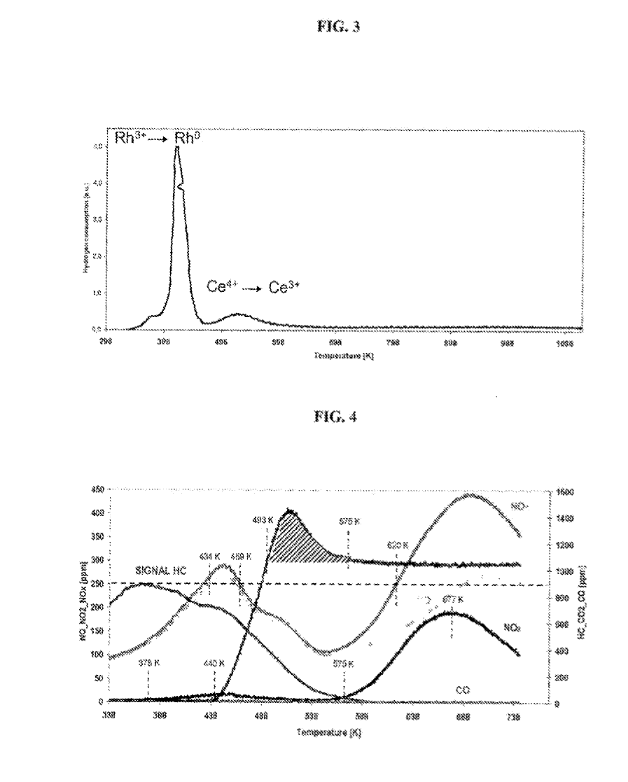

FIG. 3 represents the profile of the TPR recorded for the Rh(N)/Ce_{0.62}Zr_{0.38}O₂ catalyst. According to R. Di Monte, et al., [J. Alloys and Compounds, 275-277 (1998) 877), the peaks located below 500 K (i.e. around 227° C.) are attributed to the reduction of the deposited rhodium oxide (Rh₂O₃). The presence of two peaks may be attributed to the distribution of Rh₂O₃ particles of variable sizes. The reduction of well-dispersed rhodium oxide takes place at a lower temperature than the reduction of large crystallites. Nevertheless, the high consumption of hydrogen observed at around 419 K (i.e. around 146° C.) may also suggest the reduction of the nitrates of the support since the solid solution of ceria-zirconia mixed oxide was obtained by the hydrothermal method using rhodium nitrate as the rhodium precursor. The analysis of the results of the temperature-programmed reduction made it possible to observe that the addition of rhodium to the ceria-zirconia mixed oxides considerably reduces the reduction temperature of their surface (the reduction of the support alone took place at around 580 K (i.e. around 307° C.)). This phenomenon is linked to the reduction of rhodium which, in its metallic form at low temperatures, is capable of dissociating the dihydrogen molecules. The atomic hydrogen then migrates to the support and reduces the surface of the oxide. High consumptions of hydrogen are observed between 335 K (i.e. around 62° C.) and 439 K (i.e. around 166° C.) and also a shift to a lower temperature of the surface reduction peaks and of the core reduction peaks. The appearance of the new peak at low temperature is linked to the reduction of the rhodium oxide and of the surface of ceria.

### Example 2

### Use of the Catalytic Composition for the Treatment of a Gaseous Mixture

A gaseous mixture was treated by the samples of catalytic composition according to the invention and, by way of comparison, by a sample of mixed oxide not bearing rhodium.

In table 3, the volume composition of the gaseous mixture to be treated is given in the second column and the amount of hydrocarbon calculated for one atom of carbon is given in the third column (C₁ for CₙH₂₊ₙ=1/n).

TABLE 3

| | Volume | Volume composition C₁ |
|---|---|---|
| Compound | composition [ppm] | [ppm] |
| NO | 250 | — |
| Toluene | 64 | 450 |
| C₃H₆ | 133 | 400 |
| C₃H₈ | 50 | 150 |
| O₂ | 5% | — |
| Ar | Balance | — |

The catalysis tests were carried out by passing the gaseous mixture to be treated over the catalytic composition or over the mixed oxide at atmospheric pressure with a flow rate of 0.25 l/min. The flow rates of the gases were controlled by BROOKS SERIES® 5850E mass flowmeters. The tests were carried out in a glass U-type reactor placed in a vertical furnace. The temperature was programmed and controlled by a Eurotherm® 2404 type temperature controller. The mass of catalyst used was determined by the hourly space velocity (HSV).

Before each experiment, the samples of catalytic composition and the sample of mixed oxide without rhodium were calcined in situ under 20% of O₂ and in Ar with a flow rate set at 0.05 l/min. The temperature profile for this calcination was as follows:
heating at 3° C./min in order to move from ambient temperature to 500° C.;
holding at 500° C. for 2 hours;
cooling to ambient temperature.

The gaseous mixtures obtained after passing over the catalytic compositions were analyzed using the SIEMENS® analysis bay equipped with four specific gas analyzers allowing the simultaneous analysis of NO, NO₂, NOₓ, HC, N₂O, CO and CO₂.

The content of nitrogen monoxide was determined continuously by an Eco Physics® CLD 700 AL analyzer, the principle of which is based on the chemiluminescence of NO and O₃ (NO+O₃═NO₂+O₂+hν).

The quantitative formation of N₂O, CO and CO₂ was observed by ULTRAMAT® 6E infrared absorption spectrometry.

The total concentration of the hydrocarbons was determined by a FIDAMAT® 5E flame ionization detector.

The presence of intermediate products was verified by gas chromatography (GC 6890N, Agilent Technologies) coupled with a mass spectrometer (MS 5973N, Agilent) and using a BROKER® IFS 66V infrared spectrometer.

The nitrogen formed during the reduction of the nitrogen oxides was analyzed using an Agilent G2890A micro-chromatograph.

The treatment tests were carried out respectively with the catalysts prepared according to example 1. The maximum conversion of the nitrogen oxides obtained and the treatment temperature range are listed in table 4 below:

TABLE 4

| | | Max. | |
|---|---|---|---|
| Sample | Rh (%)^{a} | conversion (%) | Temperature (K) |
| 1c | 0 | 27 | 580-620 |
| 1 | 0.15 | 31 | 580-660 |
| 2 | 0.35 | 35 | 590-660 |
| 3 | 0.38 | 39 | 600-680 |
| 4 | 0.52 | 50 | 620-680 |
| 5 | 1.3 | 32 | 630-700 |

^{a}by weight relative to the total weight of the catalytic composition (sample).

These results show that, for the gaseous mixture tested, it is not necessary to increase the total content of Rh beyond 0.5% since the degree of conversion is not improved in the presence of a higher content of rhodium, even during a treatment at a higher temperature.

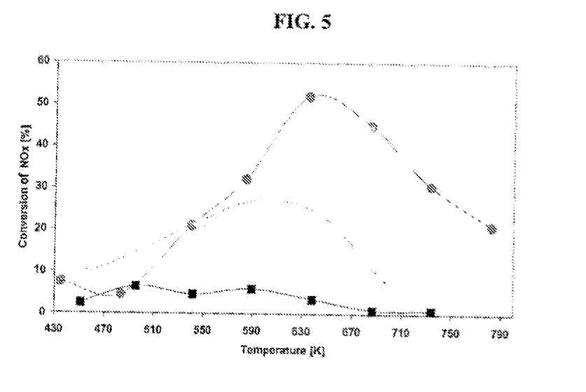

FIG. 4 presents the change in the concentrations of NO, NO₂, NO., CO, CO₂ and HC during the temperature-programmed selective reduction TPSR with the Rh(N)/Ce_{0.62}Zr_{0.38}O₂ catalyst containing 0.52% of rhodium (sample 4 from example 1). The consumption of NOₓ by this catalyst took place in a wide temperature range (469-620 K, i.e. around 196-347° C.). The temperature rise was carried out at a rate of 3° C./min. The maximum conversion was 57% at 548 K (i.e. around 275° C.).

### Example 3

The performances of an Rh(N)/Ce_{0.62}Zr_{0.38}O₂ catalyst according to the invention were compared with those of a catalyst composed of the mixed oxide without rhodium Ce_{0.62}Zr_{0.38}O₂ and those of a catalyst composed of the mixed oxide impregnated by rhodium which is only in cationic form Rh⁴⁺, according to the process described above in example 1, but using a solution of rhodium chloride instead of the solution of rhodium nitrate.

FIG. 5 represents the degree of conversion of NOₓ to N₂ as a function of the reaction temperature, during the treatment of a gaseous mixture containing 250 ppm of NO, a mixture of hydrocarbons HC (1000 C₁), 5% by volume of O₂, the balance being argon, respectively by Rh (N)/Ce_{0.62}Zr_{0.38}O₂ (), Ce_{0.62}Zr_{0.38}O₂ (▴) and Rh(Cl)/Ce_{0.62}Zr_{0.38}O₂ (▪), said catalysts having been previously calcined for 2 hours at 773 K (i.e. approximately 500° C.), HSV=30 000 h⁻¹.

The results obtained show that starting from a treatment temperature of 580 K (i.e. approximately 307° C.), the degree of conversion of NO obtained using the catalyst according to the invention is very significantly greater than the degree of conversion obtained with the two other catalysts, and reaches 20% at around 600 K (i.e. approximately 327° C.).

1. A catalytic composition composed of particles of a solid solution of cerium zirconium oxide cCeO₂,zZrO₂ in which 0.08≦c/z≦4.1, said particles bearing rhodium, wherein:
the total amount of rhodium is less than 1.3% by weight relative to the total weight of the catalytic composition;
at least 50% by weight of the total amount of rhodium is in the form of Rh₂O₃, said amount being determined by X-ray photoelectron spectrometry; and
the additional amount of rhodium is composed of cationic rhodium in the form of Rh⁴⁺.

2. The catalytic composition as claimed in claim 1, wherein the c/z ratio of the solid solution of cerium zirconium oxide is 1.63, which corresponds to the atomic composition Ce_{0.62}Zr_{0.38}O₂.

3. The catalytic composition as claimed in claim 1, which it contains from 0.65% to 1.25% by weight of Rh₂O₃ and from 0.05 to 0.65% by weight of rhodium cations in Rh⁴⁺ form.

4. A process for preparing a catalytic composition as defined in any one of the preceding claims, consisting in bringing a powder of cerium zirconium oxide cCeO₂,zZrO₂ in which 0.08≦c/z≦4.1 into contact with an aqueous solution of rhodium precursor, then in subjecting the powder impregnated by the solution to a heat treatment, wherein the rhodium precursor is rhodium nitrate, and wherein the heat treatment comprises, in this order, at least:
a step of removing water, during which the nitrate is converted to Rh₂O₃;
a step of reducing to a temperature of less than 350° C., said step aiming to stabilize the rhodium at the surface of the cerium zirconium oxide; then
a calcination step, which aims to oxidize the active phase.

5. The process as claimed in claim 4, wherein the cerium zirconium oxide powder has the composition Ce_{0.62}Zr_{0.38}O₂.

6. The process as claimed in claim 5, wherein the heat treatment carried out on the Ce_{0.62}Zr_{0.38}O₂ powder impregnated by the solution of rhodium nitrate comprises, in this order, the following steps:
a) maturation by holding the impregnated powder at ambient temperature for at least 3 hours;
b) drying by holding at a temperature of 90° C. to 110° C.;
c) reduction of Rh₂O₃ formed at the end of step b) to Rh⁰, and reduction of the Ce_{0.62}Zr_{0.38}O₂ support by holding under a stream of hydrogen at a temperature of 250° C. to 320° C.; then
d) calcination at a temperature of 420° C. to 520° C. for at least 2 hours, in order to reoxidize the rhodium Rh⁰ to Rh₂O₃ and Rh⁴⁺.

7. The process as claimed in claim 6, wherein a sub-step of holding at a temperature of 70° C. to 90° C. is carried out between step a) and step b).

8. The process as claimed in claim 6, wherein during step c), the material resulting from step b) is heated with a rate of less than 10° C. per minute.

9. The process as claimed in any one of claim 6, wherein the material resulting from step c) is brought to the temperature of step d) at a heating rate of 1 to 5° C. per minute.

10. The process as claimed in any one of claim 6, wherein at the end of step d), and before its use for the treatment of combustion gases, the catalytic composition is subjected to a pretreatment by a mixture of oxygen at 20% by volume in argon.

11. The use of a catalytic composition as defined in any one of claim 1, for treating coal combustion gases.

12. A catalytic system, which comprises a porous ceramic structure in which the surface of the pores is covered by a catalytic composition as defined in any one of claim 1.

13. A process for treating coal combustion gases, which consists in passing said gases over a catalytic composition as defined in any one of claim 1.

14. The process for treating coal combustion gases as claimed in claim 13, wherein said gases pass over at a temperature that varies from 277° C. to 473° C.

15. The process for treating coal combustion gases as claimed in claim 13, wherein the gases to be treated are brought into contact with a layer of catalytic composition in powder form placed as a thin layer on quartz wool, and wherein the gaseous mixture to be treated is passed over the powder with a sufficiently high gas flow rate to agitate the powder.

16. The process for treating coal combustion gases as claimed in claim 13, wherein use is made of a catalytic structure composed of a porous ceramic monolith, the pores of which are covered with the catalytic composition.
